(19) United States
(12) Patent Application Publication
(10) Pub. No.: US 2004/0081542 A1
(43) Pub. Date: Apr. 29, 2004

(54) Tow bar accessories for towing heavy duty vehicles

(76) Inventors: Pablo Nolasco, Corona, NY (US); Harry E. Brown, Bay Shore, NY (US)

Correspondence Address: ALFRED M. WALKER, 225 OLD COUNTRY ROAD, MELVILLE, NY, 11747-2712, US

(21) Appl. No.: 10/281,902

(22) Filed: Oct. 28, 2002

(51) Int. Cl. B66C 1/00

(52) U.S. Cl. 414/563

(57) ABSTRACT

Accessories for tow trucks enable the tow truck to lift and tow heavy-duty vehicles, such as municipal buses and heavy-duty trucks. A bus adapter engages an anchor, which extends from the front or rear frame of the bus. The frame anchor may be a downwardly extending anchor member or horizontally extending anchor portion extending parallel to the frame of the bus. In an embodiment for lifting heavy duty multi-axle trucks, linear components slides into other linear component to form wheel lifts scoops. Some of the components include a hollow collar for joining the linear components Another adapter is a tow chain adapter, having therein a tow chain with a lifting hook for engaging a chain supporting frame portions of a heavy-duty vehicle such as a bus or a truck.

### FIELD OF THE INVENTION

The present invention relates to tow bar accessories for heavy-duty vehicles, such as multi-axle trucks and municipal buses.

### BACKGROUND OF THE INVENTION

Wheel lifts are known for towing disabled vehicles, especially cars. These wheel lifts include manually applied extensions, forming either a box or L-shape or otherwise, coming in pairs, which encircle respective front or rear wheels of the disabled vehicle. The wheel lifts are generally extended laterally off of a crossbar, which extends from the central hydraulic probe arm of a tow truck.

To lift a disabled vehicle, the probe arm is hydraulically extended rearward so that the wheel lift members are in the vicinity of the front or rear wheel pairs of the disabled vehicle. The wheel lift arms are either manually wrapped around each wheel of the respective pairs of wheels or the wheel lift arms are automatically wrapped around the wheels, such as in Applicant's issued U.S. Pat. No. 6,139,250, which describes a wheel lift for vehicles which moves both laterally and pivotably around the wheels.

Older systems for lifting heavy duty motor vehicles and municipal buses include manually applied wheel lifts; however, the systems are difficult to use with heavy duty and heavy weight vehicles, such as trucks and municipal buses.

For example, U.S. Pat. No. 4,904,146 of Lock describes a wheel lift with a pair of L-shaped wheel supporting cradles 14 extending in a direction perpendicular to a crossbar 26. First, it is noted that any welded joint of two members joined at an elbow joint is inherently weak, such as L-shaped wheel supporting cradles 14 of Lock '146. Furthermore, the fixed leg 42 of each cradle 14, which is perpendicular to the elongated arm 40 of the L-shaped cradle 14, is not supported by a collar, to absorb the stress of the joint joining leg 42 to elongated arm 40 of L-shaped wheel, which supports cradles 14 of Lock '146.

Furthermore, any L-shaped member, such as cradle 14 of Lock '146 is inherently heavy, because it permanently joins two components.

In addition, the length of elongated arm 40 of Lock '146 is only adjustable in a direction parallel to the probe arm 12 of Lock '146.

Traditionally, heavy-duty vehicles such as multi-axle trucks or municipal buses are lifted by upwardly extending forks, which wrap around the frame of the vehicle from underneath and then lift the vehicle upward. However, such frame engagable fork members are tedious to install in place.

### OBJECTS OF THE PRESENT INVENTION

It is therefore an object of the present invention to provide heavy-duty accessories for lifting multi-axle trucks and municipal buses.

It is also an object to provide modular, linear components for a wheel lift for heavy-duty vehicles, which have strong but removable joints, and which avoid the weakness of permanent L-shaped components having welded joints at their elbow joints.

It is also an object of the present invention to make adjustable accessories for lifting heavy-duty vehicles.

It is further an object of the present invention to improve over the disadvantages of the prior art.

### SUMMARY OF THE INVENTION

In keeping with these objects and others, which may become apparent, the present invention includes accessories for lifting and towing heavy-duty vehicles, such as municipal buses and heavy-duty trucks.

In the bus-lifting embodiment, an accessory slider bar extender slides laterally from each end of the crossbar extending perpendicular to, and from, the rearward probe arm of the tow truck. This slider bar extender includes a hole at a top surface of one end thereof. The slider bar extender is hollow and generally square in cross section. Into the hole is inserted a locking tail anchor of a removable rear bus lift adapter.

The rear bus adapter extends vertically upward from the sliding bar extender and includes a shoulder near a top end thereof, having a yoke, including two parallel upwardly extending wings, with a recess therebetween, for insertion of the downwardly extending bus frame anchor, which extends down from the front or rear frame of the bus. The tail of the bus lift adapter is preferably circular so that it can swivel in place within the hole in the sliding bar extender, to accurately meet with, and engage, the downwardly extending anchor member of the bus frame.

Each wing of the bus lift adapter includes a respective horizontally extending through-bore, which is in positional register with another through-bore of the opposite wing, for insertion of a fastener, such as a push/pull pin with a hairpin clip, at an opposite end thereof, to lock the downwardly extending anchor member of the bus frame in place within the bus lift adapter.

While comparable dimensions are appropriate, preferably, the lower tail of the bus lift adapter is about two inches in diameter. Each wing of the pair of parallel upwardly extending wings of the lift adapter are preferably about four inches in height. A one-inch recess preferably spreads the wings apart from each other.

Made of hardened steel, or other suitable material, the rear lift adapter can lift multi-ton buses, which are disabled en route.

In some situations, the frame of the disabled bus does not have a downwardly extending anchor member, but rather has an L-shaped member which includes a first downward extending neck part and a further horizontally extending anchor portion extending parallel to the frame of the bus. This parallel extending frame portion includes a hole, which is oriented vertically. To fit such vehicles, another bus lift adapter includes a vertically extending anchor portion, which extends above the shoulder of the adapter. The shoulder has extending upward therefrom a vertically extending pin, which engages through the hole in the horizontally extending anchor portion of the bus frame anchor. A small bore is included in the top portion of the vertically extending anchor portion for insertion of a locking pin.

In the embodiment for lifting heavy duty multi-axle trucks, the present invention also includes a wheel lift with a slider arm crossbar extender, which slides into a hollow square cross sectional crossbar, which extends pivotably and generally perpendicular from the probe arm of the tow truck. A further slider crossbar extender extends at an opposite end of the transversely extending crossbar. This additional sliding crossbar extender, also lengthens the width of the crossbar. Each slider cross bar extender engages wheel slider arm member at a distal end thereof. Each wheel slider arm member includes a hollow collar, having a bore in positional register with one of the plurality of bores extending lengthwise along one of the rearward outer edges of the sliding crossbar extender. In that way, the width between the two slider arms can be adjusted. Each collar fits over each respective crossbar extender and each has extending therefrom a respective slider arm. Each slider arm is also preferably tempered steel and includes a square cross section.

At the distal end of the slider arm, which extends perpendicular to the axis of the crossbar, there is provided a further plurality of holes on each side of each slider arm, for adjusting the distance between each wheel retainer arm and each crossbar extender.

Each slider arm has the plurality of actually extending bores on an outer edge and a corresponding staggered plurality of bores on the opposite inner edge for discrete adjustments of a wheel retainer arm, which extends generally perpendicular to the slider arm so that the wheel retainer arm is generally parallel to the crossbar extender, thereby providing a space between which the wheels of a tire being lifted can be situated.

The distal end of each slider arm slides into a respective collar of the outer wheel retainer arm. The collar includes a cross sectional member having a bore with a spring loaded pin, for engagement with one of the holes on either the outer side or the inner side of the slider arm extending perpendicular to the crossbar.

The wheel retainer arm generally has a slanted surface for engaging a portion of the tire of the disabled truck. The various components of the truck slider arm are held in place by either push/pull pins, which are locked in place by hairpin clips or by spring pins. When the wheel retainer arm is positioned in place, around the outer edge of the tire, the tire is ready to be lifted and therefore the vehicle can be lifted.

Because of the extra strength caused by the collars, which may also include further welding and enforcements, the slider and wheel retaining arms of the present invention can lift heavy trucks, which cannot be lifted by standard vehicle slider arms. To further hold the wheels in place, a wheel retainer ratchet and strap wraps around circumferentially around each respective tire.

In a further embodiment, there is provided a crossbar extender member which extends within the crossbar and is held in place likewise by a fastener such as a push/pull pin and a hairpin clip. This adapter is one of a pair of tow chain adapters, having therein a tow chain with a lifting hook for engaging axles of a heavy-duty vehicle such as a bus or a truck. In this embodiment, the tow chain adapter extends likewise into the hollow square cross sectional crossbar.

### DESCRIPTION OF THE DRAWINGS

The present invention can best be understood in connection with the accompanying drawings in which:

FIG. 1 is a rear perspective view of a heavy-duty wrecker according to the present inventor;

FIG. 2 is a perspective view of an exploded crossbar with a bus yoke/pin adapter;

FIG. 3 is an exploded perspective view of the adapter as in FIG. 2 at the rear of a bus being towed;

FIG. 4 is a perspective view of an exploded crossbar with a bus dowel/pin adapter;

FIG. 5 is an exploded perspective view of the adapter as in FIG. 4 at the rear of a bus;

FIG. 6 is a rear perspective view of a crossbar with an assembled lift component;

FIG. 7 is a rear perspective exploded view thereof;

FIG. 8 is a sectional plan view taken from FIG. 7 of a slider arm, showing dimensionally off set holes;

FIG. 9 is a sectional plan view of a crossbar extender, with offset holes;

FIG. 10 is a local close-up exploded detail view of a truck front tire with towing components exploded, showing the safety of the exterior assembly;

FIG. 11 is a perspective view of a steering axle tire supported and strapped in place;

FIG. 12 is a perspective view of an embodiment with a driving axle dual tire;

FIG. 13 shows a prior art view of components on an exterior of a crossbar;

FIG. 14 is a perspective view of a crossbar with an exploded view of tow hook components;

FIG. 15 is a sectional cut view of the tow hook component inside, pinned to a crossbar; and

FIG. 16 is an elevator view of a truck chained to a bar.

### DETAILED DESCRIPTION OF THE PREFERRED EMBODIMENTS

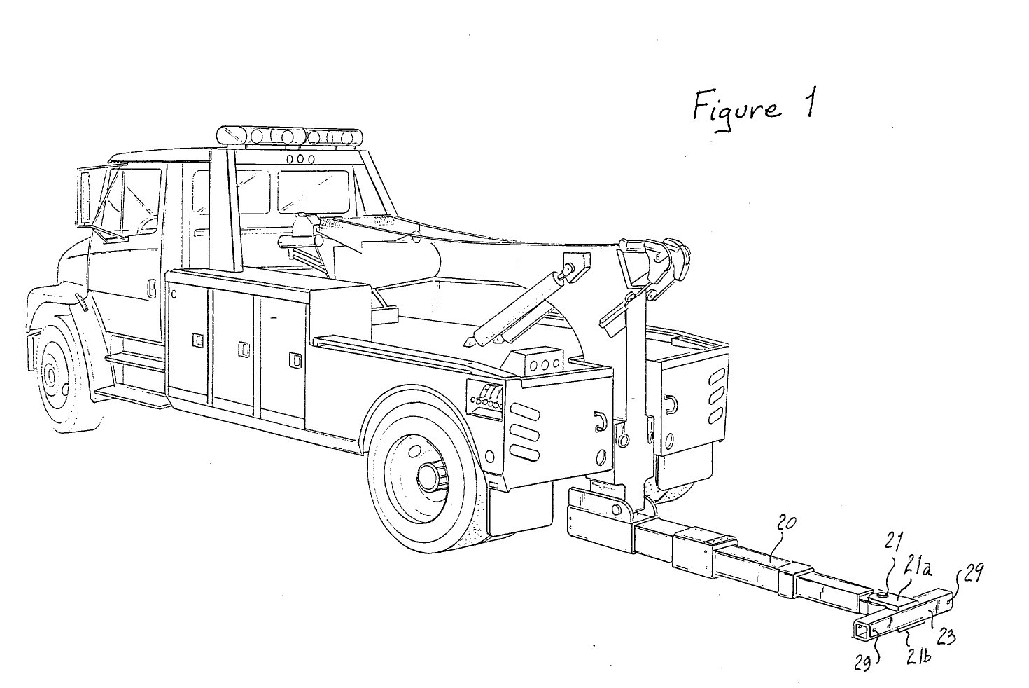

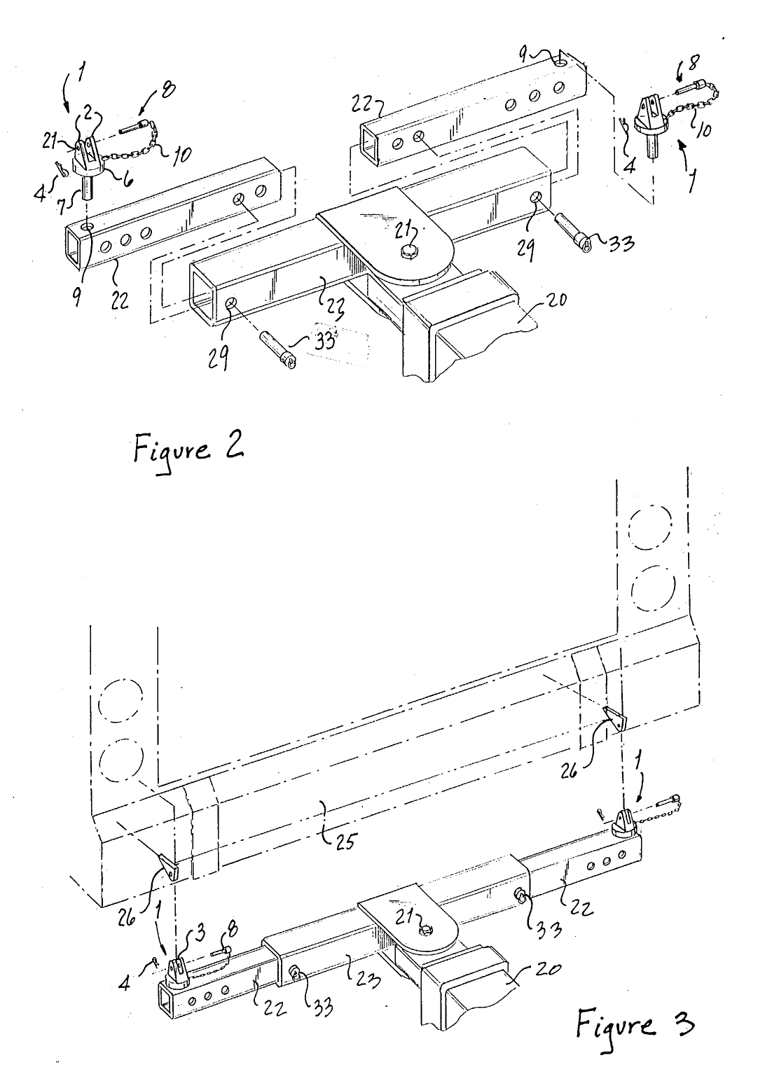

As shown in drawing FIGS. 1-16, the present invention includes various adapters and accessories for lifting heavy-duty vehicles such as trucks and municipal buses which cannot be lifted by conventional automobile wheel lift components.

FIG. 1 illustrates the rear of a typical wrecker, with a hydraulic probe arm 20 and crossbar 23. Crossbar 23 will accept the various adapters and accessories to facilitate the lifting of heavy duty vehicles. The first strength-imparting feature of the present invention shown in FIG. 1 is that pin 21, joining cross bar 23 to probe arm 20, joins upper and lower plates 21a and 21b to hold cross bar 23 in an unencumbered configuration. For example, unlike many prior art cross bars which are cut to accommodate a joint between a cross bar and a probe arm, the pin 21 and plates 21a and 21b leave cross bar 23 intact at its joint with probe arm 20. This keeps the inherent strength of cross bar 23 intact.

In addition, as further shown in FIG. 1, pin 21 extends through a bearing sleeve having a ring of roller bearings, which allows for smooth pivoting of cross bar 23 about probe arm 21, while pin 21 sandwiches cross bar 23 snugly between plates 21a and 21b.

As shown in FIGS. 1, 2 and 3, a first embodiment of a removable rear bus lift adapter 1 is insertable at a lower end thereof within one of a pair of crossbar extenders 22 and at an upper end thereof, between a pair of attachment wings 2 which have respective holes 21 in positional register with each other. Wings 2 form an open hollow yoke holding downward extending anchor 26 of bus frame 25 therein.

Wings 2 are supported by base plate 6 of adapter 1 having cylindrical tail 7 extending downward therefrom. Pin 8 is insertable within holes 21 of wings 2.

Bus lift adapter 1 swivels about tail 7 within circular hole 9 of a top wall of crossbar extender 22, to align with downwardly extending bus frame anchor 26 of bus frame 25. Anchor 26 fits in recess 3 between wings 2 and then is locked with push/pull pin 8. The latter is retained with hairpin clip 4 and is loosely attached via chain 10 to base plate 6 of the yoke portion of bus lift adapter 1.

FIG. 3 shows the arrangement of the various components of a tow truck, including hydraulic probe arm 20 having a swivel coupling via swivel pin 21 to crossbar 23. Bus lift adapter 1 is coupled to crossbar 23 by insertion of crossbar extender 22 within hollow crossbar 23.

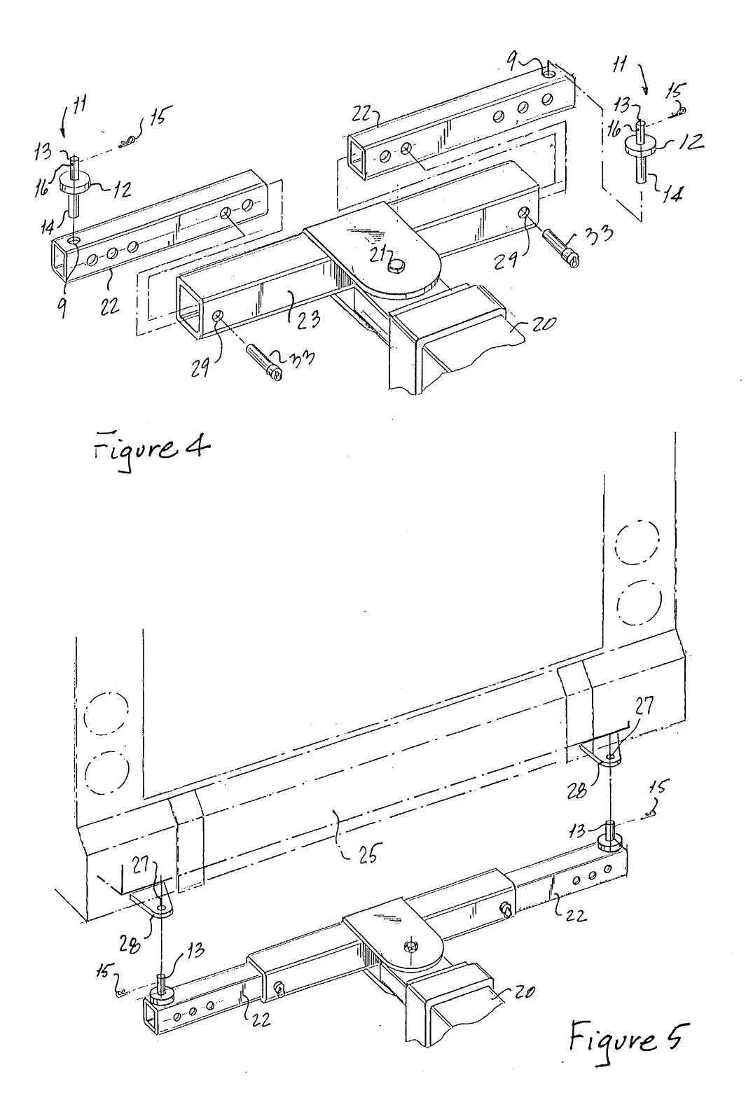

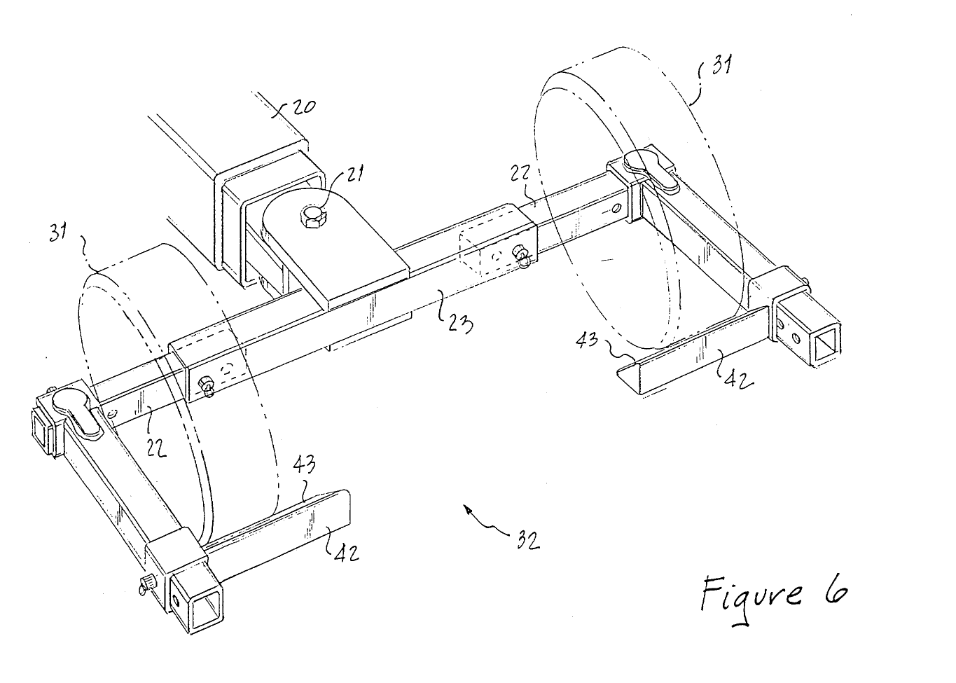

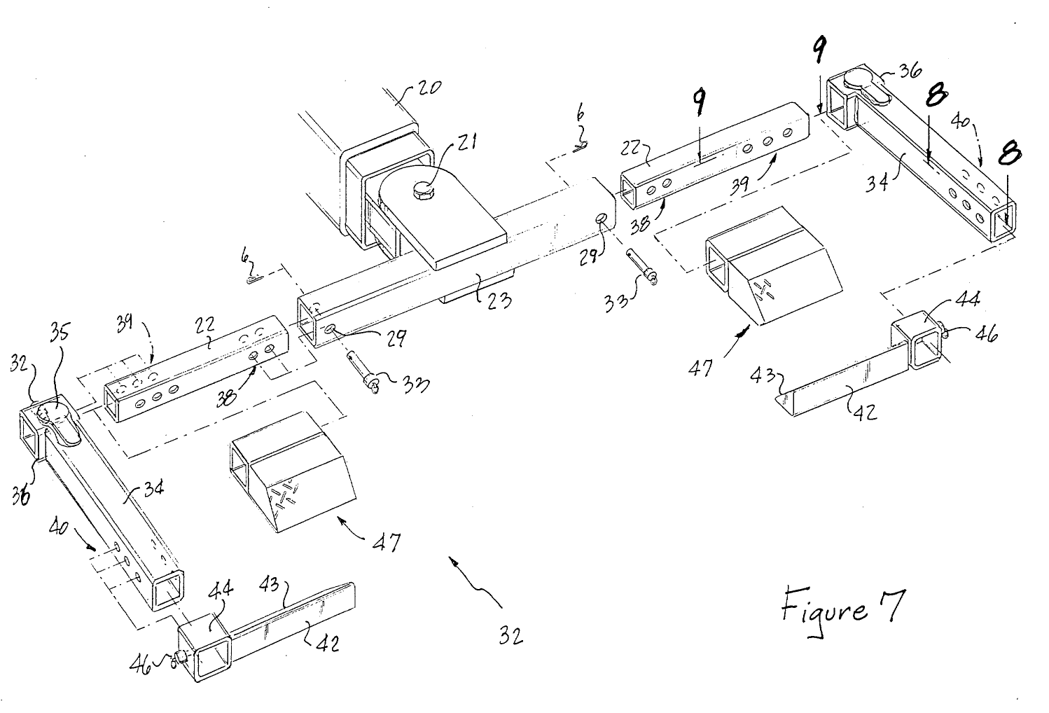

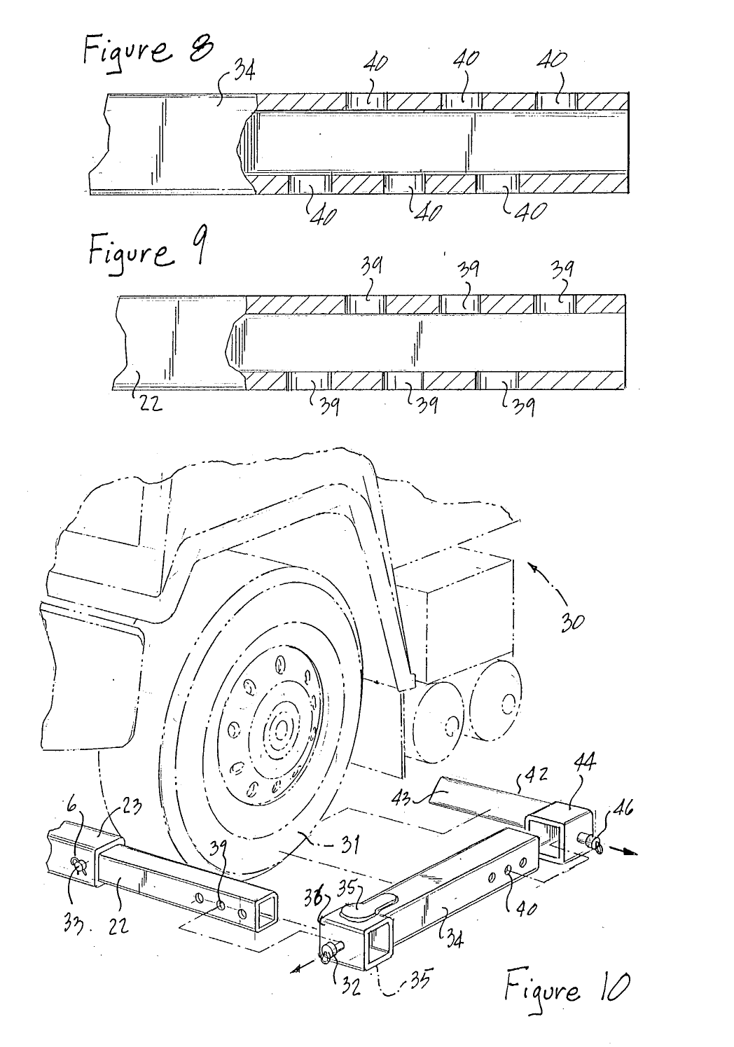

Shown in FIG. 4 and 5, is an alternate embodiment of bus lift adapter 11 which is compatible with busses having a different type of attachment fixture. Instead of the downwardly extending frame members 26, as shown in FIG. 4, some bus frames 27 have horizontal anchor members 28 with a coupling hole 27.

To accommodate this arrangement shown in FIGS. 4 and 5, bus lift adapter 11 is an upper coupling element rod 14, which is also inserted in hole 9 of each of the crossbar extenders 22. This coupling element rod 9 of bus lift adapter 11 is shown clearly in FIG. 4. Bus lift adapter 11 also includes with base plate 12 having upper coupling rod 13 extending therefrom. Extending downward from base plate 12 is cylindrical coupling element rod 14. Upper coupling rod 13 fits through hole 27 in horizontal anchor member 28 and is retained with a hair pin clip 15 inserted through small hole 16 of upper coupling element rod 13 of bus lift adapter 11.

FIGS. 6 through 12 illustrate another embodiment of this invention, which is a wheel lift 32 for heavy-duty trucks 30 having wheels 31. wheel lift 32 is adjustable both laterally as well as longitudinally and it incorporates structural design features, which minimize the concentration of torsional stresses as compared with prior art automotive wheel lifts. In that regard, the present invention avoids the inherent weakness of any prior art welded joint of two members which are joined at an elbow joint, such as L-shaped wheel supporting cradles 14 of Lock '146. In contrast, the linear bar members of the present invention are each supported by a collar which absorbs the stress of the joint joining two linear members of the heavy-duty wheel lift of the present invention.

FIG. 7 is an exploded view of the components of wheel lift 32. Crossbar 23 is shown with coupling holes 29 near the ends. These holes 29 receive push/pull pin 33 through one of holes 38 of crossbar extender 22 to adjustably couple crossbar 23 and crossbar extender 22. Push/pull pin 33 is retained with hairpin clip 6.

A collar 36 welded to slider arm 34 is locked to one of a plurality of holes 39 via spring loaded pin 32 to provide further adjustment laterally. Reinforcement plates 35 further strengthen the joint between collar 36 and slider arm 34.

Wheel retainer arm 42 has a slanted surface 43 engage vehicle tire 31 (as in FIG. 6). Wheel retainer arm 42 includes collar 44 welded to its proximal end. Collar 44 is slid over the distal end of slider arm 34 and is engaged with any of longitudinal adjustment holes 40 via spring loaded pin 46. This latter adjustment is to accommodate vehicle tires and wheels of various sizes. The engagement of two vehicle tires 31 on an axle is clearly shown in FIG. 6.

To accommodate the lifting of heavy-duty trucks, the use of full collars 36 and 44 as well as welded reinforcement plates 35 avoid stress concentrations at joints. Also, the inserted crossbar extenders 22 within the ends of crossbar 23 add torsional rigidity to this member.

FIG. 7 also shows a optional wedge adapter sleeve 47 which slides over each cross bar extender 22 to provide support and reduce the distance between the cross bar extender 22 and wheel retainer arm 42, where small tires or flat tires are being lifted.

FIGS. 8 show that slider arm 34, illustrating a staggered offset hole pattern, wherein holes 40 in one side wall of slider arm 34 are offset from holes 40 in the opposite sidewall of slider arm 34. This allows for minute adjustment of the distance of retainer arm 42 from crossbar extender 22 to permit wheel retainer arm 42 to abut tires of different sidewall dimensions and sizes.

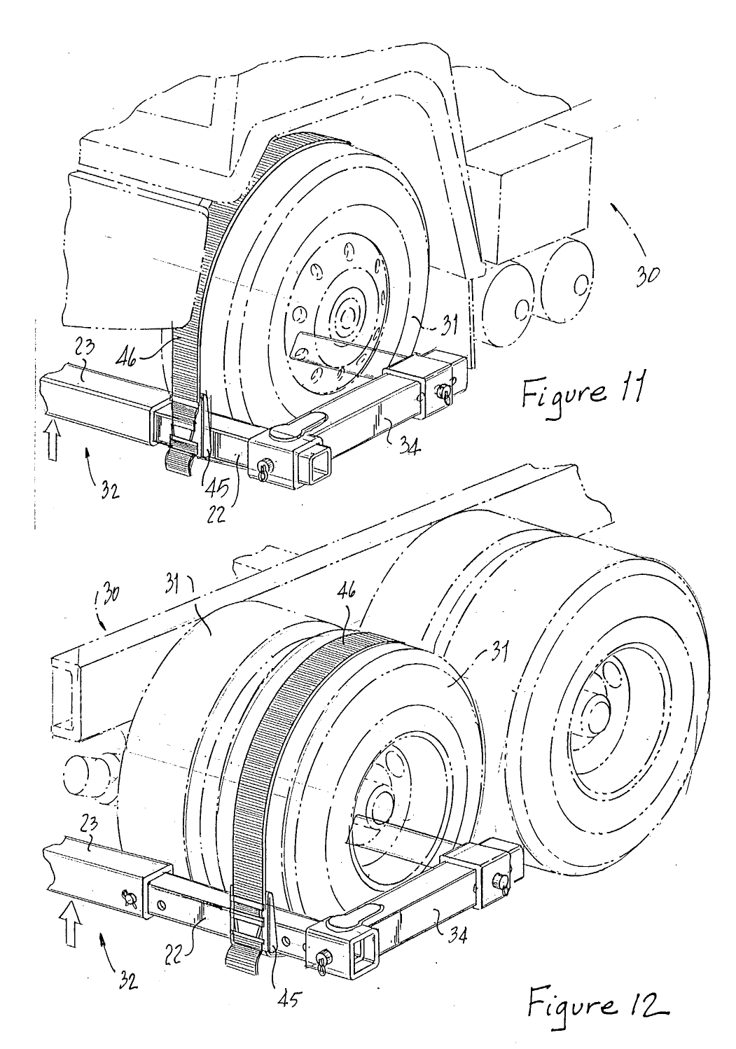

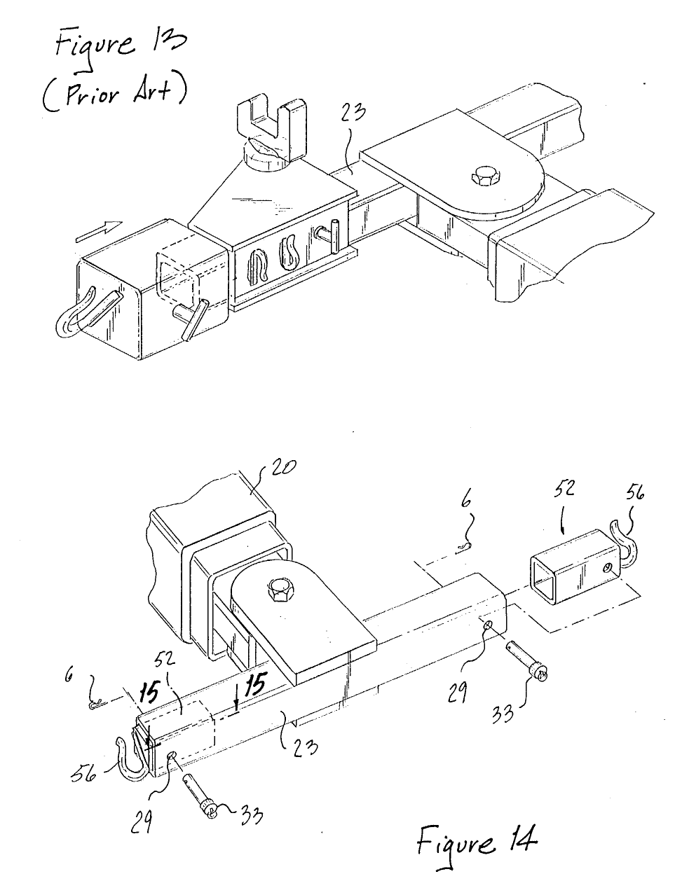

FIG. 9 is a sectional plan view of cross bar extender 22 which has a similar staggered hole pattern of holes 39 similar to holes 40 of slider arm 34. This hole pattern of holes 39 allows for minute adjustability when slider arm 34 is installed onto cross bar extender 22. Slider arm 34 can be adjusted on crossbar extender 22 to abut tires of varying tread widths, as shown in FIGS. 11 and 12.

FIG. 10 is a perspective view illustrating the assembly of components on the exterior of a heavy-duty vehicle 30. The advantage is that it provides for a safer work environment for the tow operator as he or she does not have to place him or herself in between wrecker vehicle and the heavy-duty vehicle to be towed. This is because all of the adjustable components of wheel lift 32 are installed in place outside of the outer sidewall of tire 31 to be carried.

The detail view of FIG. 11 shows how a ratchet 45 and strap 46 of wheel lift 32 are used to retain tire 31 of heavy-duty vehicle 30 on the wheel lift 32.

FIG. 13 shows a prior art chain adapter fitting on an exterior of crossbar 23, requiring relocating of accessories installed previously on cross bar 23.

In order to solve the problem of constant relocating of accessories previously installed on crossbar 23, FIGS. 14-16 show the details of a chain adapter 52 of this invention. This is used for securing a tow chain 53 which wraps axle 51 of a vehicle 50, such as a bus or truck, for towing purposes from the end of a hydraulic probe arm 20 with a crossbar 22. The chain adapter 52 fits within the ends of crossbar 23. Chain adapter 52 is retained in coupling holes 29 adjacent the ends of crossbar 23 via push/pull pins 33 and hair pin clips 6.

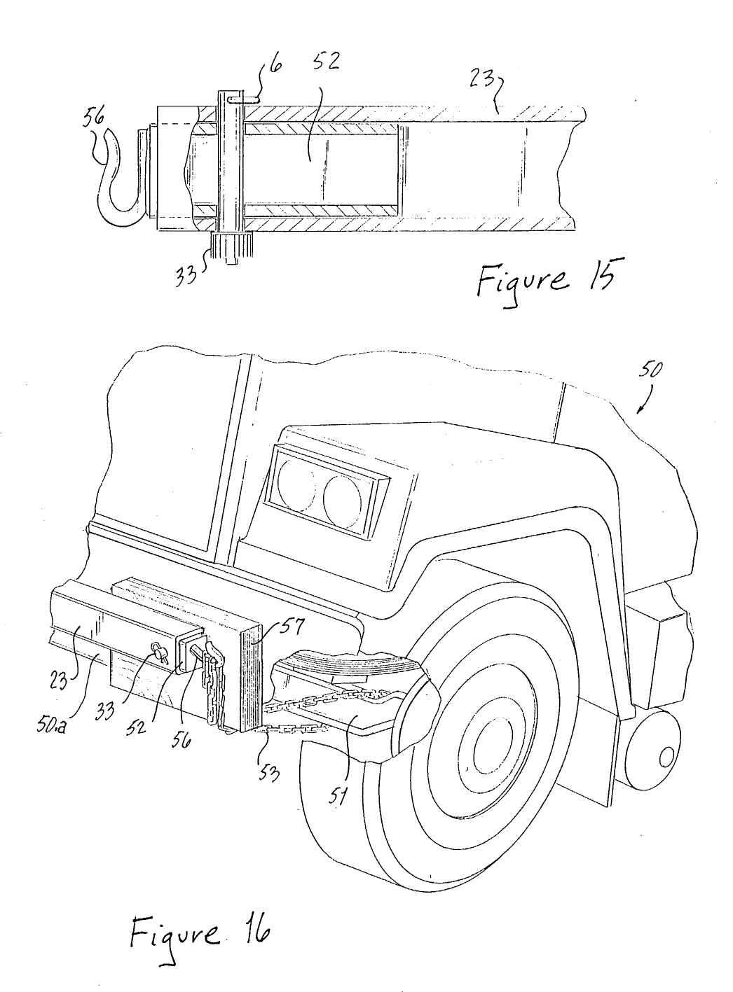

FIG. 15 is a sectional plan view illustrating the chain adapter 52 slidably installed within cross bar 23 secured by push/pull pin 33.

FIG. 16 is a detail showing the use of chain 53 around the axle 51 of vehicle 50.

As shown in FIG. 16, each of the chain adapter units 52 has a welded chain hook 56, which secures tow chain 53.

As also shown in FIG. 16, an optional block 57 of wood or other non-scratch material protects the bumper 50a or body work of heavy-duty vehicle 50 from damages from abrasive scratches caused by tow chain 53.

The present invention can best be described by the foregoing description; however, it is not meant to be limiting since the invention is to be only to the scope of the invention, as noted in the appended Claims.

I claim:

1. A lift adapter assembly for a heavy weight vehicle, comprising;
an accessory slider bar extender sliding laterally from a respective end of a crossbar extending from a rearward probe arm of a tow truck, said slider bar extender including a hole at a top surface thereof,
said slider bar extender being hollow and generally square in cross section,
said slider arm assembly including an adapter having a cylindrical locking tail insertable within said slider bar extender, said adapter having an open hollow yoke extending vertically upward from a base plate having said tail extending downward therefrom,
said open hollow yoke accommodating a downwardly extending frame anchor member extending down from one of a front and rear frame of the said vehicle,
said cylindrical downwardly extending tail of said bus lift adapter swivelable in place within said hole of said sliding bar extender to accurately meet with and engage said downwardly extending anchor member of the bus frame within said wings of said yoke of said lift adapter.

2. The lift adapter assembly as in claim 1 wherein said open hollow yoke comprises a pair of parallel upwardly extending wings having a recess therebetween accommodating said downwardly extending frame anchor member.

3. The lift adapter assembly as in claim 2, wherein each wing includes a horizontally extending through-bore,
said through-bore being open for insertion of a pin fastener, at an opposite end thereof,
said fastener locking said downwardly extending anchor member of the bus frame in place within said lift adapter.

4. The lift adapter assembly as in claim 1, wherein said heavy weight vehicle is a bus.

5. A lift adapter assembly for a heavy weight vehicle comprising;
an accessory slider bar extender sliding laterally from a respective end of a crossbar extending from a rearward probe arm of a tow truck,
said slider arm extender having a hole therein accommodating an adapter engagable with a horizontally extending anchor portion extending parallel to the frame of the bus,
said parallel extending frame portion including a hole which is oriented vertically,
said lift adapter including a horizontal anchor portion above a support plate, said support plate having extending therefrom a vertically extending pin which engages through said hole in said horizontally extending anchor portion of said bus frame anchor.

6. The lift adapter assembly as in claim 5, wherein a small bore is included in a top portion of said vertically extending member for insertion of a locking pin therethrough.

7. A lift adapter assembly for lifting heavy-duty multi-axle trucks, said adapter assembly comprising;
an accessory slider arm crossbar extender slidable into a hollow crossbar extending pivotably and generally perpendicular from a probe arm of a tow truck,
said accessory sliding crossbar extender being slidable within a crossbar extending perpendicular to the probe arm of the truck;
said slider crossbar extender having an open hollow collar having a bore in positional register with one of the plurality of bores extending lengthwise along one of outer edges of said sliding crossbar extender, said open hollow collar fitting over said crossbar extender, wherein at a distal end of said slider arm extending perpendicular to the axis of said crossbar, there is provided a plurality of holes on each side of each slider arm,
each said slider arm having a plurality of extending bores on an outer edge and a corresponding staggered plurality of bores on the opposite inner edge for discrete adjustments of a position of a wheel retainer arm,
said wheel retainer arm extending generally perpendicular to said slider arm so that said wheel retainer arm is generally parallel to said crossbar extender, thereby providing a space between which the wheels of a tire being lifted can be situated,
wherein at a distal end of said slider arm there is situated a collar of said wheel retainer arm, including a member having a bore with a spring loaded pin, for engagement with one of the holes on either said outer side or said inner side of said slider arm extending perpendicular to said crossbar.

8. The lift adapter assembly as in claim 7, wherein said wheel retainer arm includes a slanted surface engaging a portion of a tire of a disabled truck.

9. A chain adapter for engaging frame portions of a heavy weight vehicle for towing purposes from the end of a hydraulic probe arm with a crossbar, comprising:
a pair of chain adapter units fitting within respective ends of a crossbar attached to a rearward probe arm of a tow truck,
said chain adapters being retained in respective coupling holes adjacent respective ends of said crossbar via fasteners, each of said chain adapters having a welded chain hook, engagable with a removable chain, said chain being wrapped around the frame of the vehicle.

10. A joint joining a probe arm of a wrecker tow vehicle to a cross bar accommodating towing accessories for to facilitate the lifting of heavy duty vehicles, said joint comprising:
a pin joining said cross bar to said probe arm, said pin joining respective upper and lower plates holding said cross bar therebetween in an unencumbered configuration, said cross bar being unencumbered by a cut-out,
said pin extending through a bearing sleeve having a ring of roller bearings, said bearing sleeve causing smooth pivoting of said cross bar about said probe arm,
said pin sandwiching said cross bar snugly between said respective upper and lower plates.
